(19) United States
(12) Patent Application Publication
(10) Pub. No.: US 2022/0275714 A1
(43) Pub. Date: Sep. 1, 2022

(54) A HYBRID DEEP PHYSICS NEURAL NETWORK FOR PHYSICS BASED SIMULATIONS

(71) Applicant: LANDMARK GRAPHICS CORPORATION, Houston, TX (US)

(72) Inventors: Srinath MADASU, Houston, TX (US); Keshava Prasad RANGARAJAN, Sugar Land, TX (US)

(73) Assignee: LANDMARK GRAPHICS CORPORATION, Houston, TX (US)

(21) Appl. No.: 17/628,610

(22) PCT Filed: Aug. 30, 2019
(86) PCT No.: PCT/US2019/049181

§ 371 Date: Jan. 20, 2022

(51) Int. Cl. E21B 43/16

(52) U.S. Cl. CPC E21B 43/16; E21B 2200/20; E21B 2200/22

(57) ABSTRACT

Aspects of the subject technology relate to systems and methods for predicting physical characteristics of a physical environment using a physical characterization model trained based on simulated states of a modeled physical environment. A physical characterization model can be generated based on a plurality of simulated states of a modeled physical environment. Specifically, the physical characterization model can be trained by mapping simulated spatial properties of the modeled physical environment temporally across the plurality of simulated states of the modeled physical environment. Further, input state data describing one or more input states of a physical environment can be received. One or more physical characteristics of the physical environment can be predicted by applying the physical characterization model to the one or more input states of the physical environment.

### TECHNICAL FIELD

The present technology pertains to predicting physical characteristics of a physical environment, and more particularly, to predicting physical characteristics of a physical environment using a physical characterization model trained based on simulated states of a modeled physical environment.

### BACKGROUND

Simulating physical environments to identify characteristics of the physical environments has numerous applications across a wide array of industries. Specifically, in the exploration and production of hydrocarbons, a large number of reservoir engineering decisions are made from reservoir simulation results. Additionally, simulated natural fracture networks in mediums are used to conduct hydraulic fracturing in the mediums. However, simulating physical environments can consume large amounts of time and computational resources, especially as the physical environments become more and more complex. For example, creating reservoir simulations can consume large amounts of time and computational resources due to both grid complexity and non-linearity of the reservoir simulations. Further, physical environments often need to be simulated multiple times in order to increase the accuracy of model predictions or to perform history matching. This process of repeatedly simulating physical environments further consumes more time and computational resources.

### BRIEF DESCRIPTION OF THE DRAWINGS

In order to describe the manner in which the features and advantages of this disclosure can be obtained, a more particular description is provided with reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A is a schematic diagram of an example logging while drilling (LWD) wellbore operating environment, in accordance with various aspects of the subject technology;

FIG. 1B is a schematic diagram of an example downhole environment having tubulars, in accordance with various aspects of the subject technology;

FIG. 2 illustrates a flowchart for an example method of generating a physical characterization model based on simulated states of a modeled physical environment, in accordance with various aspects of the subject technology;

FIG. 3 illustrates a flowchart for an example method of applying a physical characterization model to predict one or more physical characteristics of a physical environment, in accordance with various aspects of the subject technology;

FIG. 4A shows an example stress distribution of a reservoir at an initial state, in accordance with various aspects of the subject technology;

FIG. 4B shows an example stress distribution of the reservoir at a final state, in accordance with various aspects of the subject technology;

FIG. 4C shows a comparison between the simulated stress distribution at the final state and a stress distribution at the final state predicted using a physical characterization model, in accordance with various aspects of the subject technology;

FIG. 5A shows an example pressure distribution of a reservoir at an initial state, in accordance with various aspects of the subject technology;

FIG. 5B shows an example pressure distribution of the reservoir at a final state, in accordance with various aspects of the subject technology;

FIG. 5C shows a comparison between the simulated pressure distribution at the final state and a pressure distribution at the final state predicted using a physical characterization model, in accordance with various aspects of the subject technology; and

FIG. 6 illustrates an example computing device architecture which can be employed to perform various steps, methods, and techniques disclosed herein.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Simulating physical environments to identify characteristics of the physical environments has numerous applications across a wide array of industries. Specifically, in the exploration and production of hydrocarbons, a large number of reservoir engineering decisions are made from reservoir simulation results. Additionally, simulated natural fracture networks in mediums are used to conduct hydraulic fracturing in the mediums. However, simulating physical environments can consume large amounts of time and computational resources, especially as the physical environments become more and more complex. For example, creating reservoir simulations can consume large amounts of time and computational resources due to both grid complexity and non-linearity of the reservoir simulations. Further, physical environments often need to be simulated multiple times in order to increase the accuracy of model predictions or to perform history matching. This process of repeatedly simulating physical environments further consumes more time and computational resources.

The disclosed technology addresses the foregoing by predicting physical characteristics of a physical environment using a physical characterization model. Specifically, the physical characteristics of the physical environment can be predicted using the physical characterization model that is trained based on simulated states of a modeled physical environment. In turn, physical characteristics of the physical environment can be accurately predicted, e.g. using a refined grid, without repeatedly simulating the environment.

In various embodiments, a physical characterization model is generated based on a plurality of simulated states of a modeled physical environment. The physical characterization model can be trained by mapping simulated spatial properties of the modeled physical environment temporally across the plurality of simulated states of the modeled physical environment. Further, input state data describing one or more input states of a physical environment can be received. As follows, one or more physical characteristics of the physical environment can be predicted by applying the physical characterization model to the one or more input states of the physical environment.

In various embodiments, A system can include one or more processors and at least one computer-readable storage medium storing instructions which, when executed by the one or more processors, cause the one or more processors to simulate a modeled physical environment to generate a plurality of simulated states of the modeled physical environment. The instructions can also cause the one or more processors to train a physical characterization model based on the plurality of simulated states. Specifically, the instructions can cause the one or more processors to map simulated spatial properties of the modeled physical environment temporally across the plurality of simulated states of the modeled physical environment to train the physical characterization model. Further, the instructions can cause the one or more processors to deploy the physical characterization model to predict one or more physical characteristics of a physical environment by applying the physical characterization model to one or more input states of the physical environment.

In various embodiments, a system can include a non-transitory computer-readable storage medium having stored therein instructions which, when executed by a processor, cause the processor to instantiate a physical characterization model generated based on a plurality of simulated states of a modeled physical environment. The physical characterization model can be trained by mapping simulated spatial properties of the modeled physical environment temporally across the plurality of simulated states of the modeled physical environment. The instructions can also cause the processor to receive input state data describing one or more input states of a physical environment. Further, the instructions can cause the processor to predict one or more physical characteristics of the physical environment by applying the physical characterization model to the one or more input states of the physical environment.

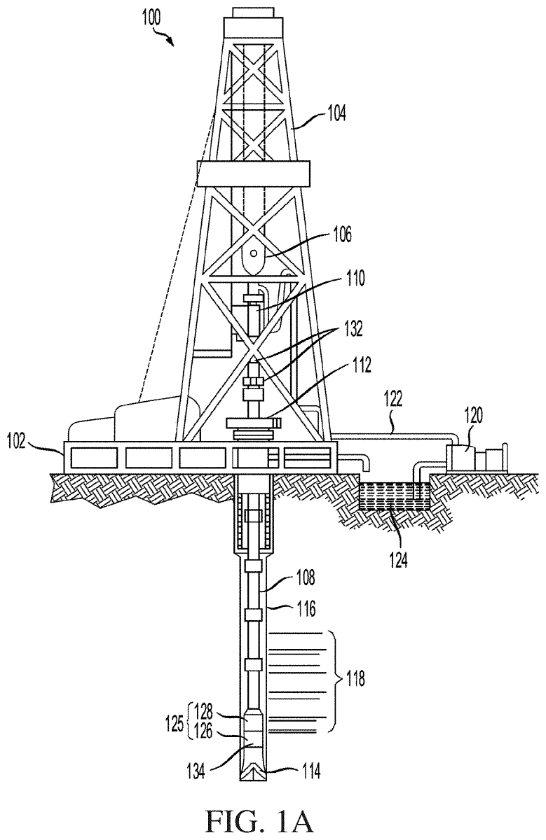

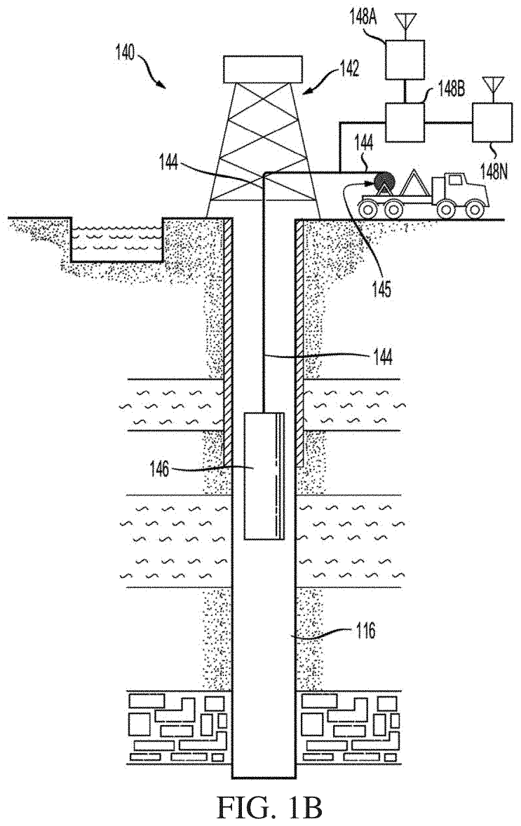

Turning now to FIG. 1A, a drilling arrangement is shown that exemplifies a Logging While Drilling (commonly abbreviated as LWD) configuration in a wellbore drilling scenario 100. Logging-While-Drilling typically incorporates sensors that acquire formation data. The drilling arrangement of FIG. 1A also exemplifies what is referred to as Measurement While Drilling (commonly abbreviated as MWD) which utilizes sensors to acquire data from which the wellbore's path and position in three-dimensional space can be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, it creates a wellbore 116 that passes through various subterranean formations 118. A pump 120 circulates drilling fluid through a supply pipe 122 to top drive 110, down through the interior of drill string 108 and out orifices in drill bit 114 into the wellbore. The drilling fluid returns to the surface via the annulus around drill string 108, and into a retention pit 124. The drilling fluid transports cuttings from the wellbore 116 into the retention pit 124 and the drilling fluid's presence in the annulus aids in maintaining the integrity of the wellbore 116. Various materials can be used for drilling fluid, including oil-based fluids and water-based fluids.

Logging tools 126 can be integrated into the bottom-hole assembly 125 near the drill bit 114. As the drill bit 114 extends the wellbore 116 through the formations 118, logging tools 126 collect measurements relating to various formation properties as well as the orientation of the tool and various other drilling conditions. The bottom-hole assembly 125 may also include a telemetry sub 128 to transfer measurement data to a surface receiver 132 and to receive commands from the surface. In at least some cases, the telemetry sub 128 communicates with a surface receiver 132 using mud pulse telemetry. In some instances, the telemetry sub 128 does not communicate with the surface, but rather stores logging data for later retrieval at the surface when the logging assembly is recovered.

Each of the logging tools 126 may include one or more tool components spaced apart from each other and communicatively coupled by one or more wires and/or other communication arrangement. The logging tools 126 may also include one or more computing devices communicatively coupled with one or more of the tool components. The one or more computing devices may be configured to control or monitor a performance of the tool, process logging data, and/or carry out one or more aspects of the methods and processes of the present disclosure.

In at least some instances, one or more of the logging tools 126 may communicate with a surface receiver 132 by a wire, such as wired drill pipe. In other cases, the one or more of the logging tools 126 may communicate with a surface receiver 132 by wireless signal transmission. In at least some cases, one or more of the logging tools 126 may receive electrical power from a wire that extends to the surface, including wires extending through a wired drill pipe.

Collar 134 is a frequent component of a drill string 108 and generally resembles a very thick-walled cylindrical pipe, typically with threaded ends and a hollow core for the conveyance of drilling fluid. Multiple collars 134 can be included in the drill string 108 and are constructed and intended to be heavy to apply weight on the drill bit 114 to assist the drilling process. Because of the thickness of the collar's wall, pocket-type cutouts or other type recesses can be provided into the collar's wall without negatively impacting the integrity (strength, rigidity and the like) of the collar as a component of the drill string 108.

Referring to FIG. 1B, an example system 140 is depicted for conducting downhole measurements after at least a portion of a wellbore has been drilled and the drill string removed from the well. A downhole tool is shown having a tool body 146 in order to carry out logging and/or other operations. For example, instead of using the drill string 108 of FIG. 1A to lower tool body 146, which can contain sensors and/or other instrumentation for detecting and logging nearby characteristics and conditions of the wellbore 116 and surrounding formations, a wireline conveyance 144 can be used. The tool body 146 can be lowered into the wellbore 116 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars.

The illustrated wireline conveyance 144 provides power and support for the tool, as well as enabling communication between data processors 148A-N on the surface. In some examples, the wireline conveyance 144 can include electrical and/or fiber optic cabling for carrying out communications. The wireline conveyance 144 is sufficiently strong and flexible to tether the tool body 146 through the wellbore 116, while also permitting communication through the wireline conveyance 144 to one or more of the processors 148A-N, which can include local and/or remote processors. Moreover, power can be supplied via the wireline conveyance 144 to meet power requirements of the tool. For slickline or coiled tubing configurations, power can be supplied downhole with a battery or via a downhole generator.

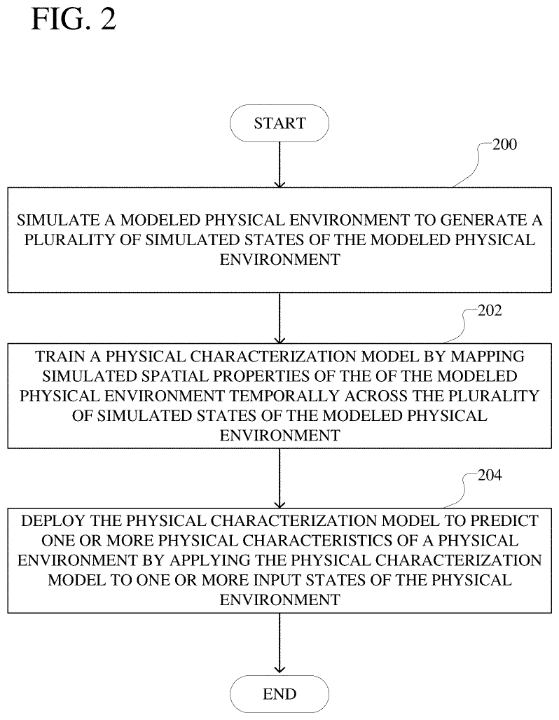

FIG. 2 illustrates a flowchart for an example method of generating a physical characterization model based on simulated states of a modeled physical environment. The method shown in FIG. 2 is provided by way of example, as there are a variety of ways to carry out the method. Additionally, while the example method is illustrated with a particular order of steps, those of ordinary skill in the art will appreciate that FIG. 2 and the modules shown therein can be executed in any order and can include fewer or more modules than illustrated. Each module shown in FIG. 2 represents one or more steps, processes, methods or routines in the method.

As will be discussed in greater detail later, the physical characterization model can be used to predict one or more physical characteristics of a physical environment. Physical characteristics of a physical environment can include applicable characteristics of a physical environment that are capable of being simulated through a physical simulation, e.g. the material point method. For example and as will be discussed in greater detail later, physical characteristics of a rock formation can include stresses and strains in a natural fracture network of the rock formation.

Using the physical characterization model to predict physical characteristics of a physical environment can supplant the need to physically simulate the physical environment in order to predict the physical characteristics. For example and as will be discussed in greater detail later, once the model is trained using simulated physical data, the model can be applied to predict physical characteristics of the physical environment. Specifically, the model can be applied to predict the physical characteristics of the physical environment, without having to further simulate the physical environment. This is advantageous as simulating physical environments, in particular complex physical environments, consumes large amounts of time and computational resources. Therefore, applying the physical characterization model without having to simulate the physical environment or re-simulate the physical environment after the model is created can save time while reducing used computational resources.

Returning back to the example method shown in FIG. 2, at step 200, a modeled physical environment is simulated to generate a plurality of simulated states of the modeled physical environment. The modeled physical environment can be simulated by an applicable simulation/simulation tool for simulating a physical environment to predict physical characteristics of the environment. For example, the modeled physical environment can be simulated using the material point method.

In simulating the modeled physical environment to generate a simulated state, simulated spatial properties of the modeled physical environment, as included as part of the simulated state, can be generated. Simulated spatial properties can include space-dependent simulated properties, e.g. physical characteristics, of the modeled physical environment at specific spatial locations within the modeled physical environment. For example, a simulated spatial property of the modeled physical environment can include material properties, e.g. permeability, porosity, a Poisson's ratio, and a Young's modulus, of material/materials at a specific spatial location in the modeled physical environment. Simulated spatial properties of the modeled physical environment can be space-dependent within the modeled physical environment. In being space-dependent, the simulated spatial properties can vary within the modeled physical environment based on the corresponding spaces of the simulated spatial properties. For example, simulated stresses in a simulated medium can vary across corresponding spatial locations within the simulated medium.

The modeled physical environment can be simulated based on a spatial grid, e.g. a defined spatial grid, for the modeled physical environment. A spatial grid can specify spatial points and/or regions within the modeled physical environment at or about which to simulate spatial properties for simulating the modeled physical environment. For example, a spatial grid can include 10 foot by 10 foot grid squares within the modeled physical environment. Further in the example, spatial properties can be simulated for each 10 foot by 10 foot grid square within the modeled physical environment. In simulating a modeled physical environment based on a spatial grid, simulated spatial properties of the modeled physical environment can include grid associated properties of the modeled physical environment. In particular, simulated spatial properties can be specific to corresponding locations within a spatial grid that is used to simulate the modeled physical environment. For example, simulated spatial properties can include stresses in materials within specific spatial grid squares of a spatial grid used to simulate the modeled physical environment.

Simulated spatial properties of the modeled physical environment can depend upon each other. Specifically, grid associated properties of the modeled physical environment can depend on grid associated properties at neighboring and adjacent locations in the spatial grid of the modeled physical environment. For example, a simulated strain in a first grid of the modeled physical environment can be related to/depend upon a simulated strain in a second grid adjacent to the first grid. The grid associated properties/simulated spatial properties can depend upon each other based on grid connectivity that relates neighboring and adjacent spatial/grid locations. Grid connectivity includes applicable parameters that relate physical characteristics of the modeled physical environment at different spatial/grid locations. For example, grid connectivity can include that differences in material properties of materials in first and second grid squares will cause a fracture to grow ten percent faster in the first grid square compared to the second grid square. The physical characterization model can be generated/trained based on grid connectivity in the modeled physical environment. Specifically, simulated spatial properties/grid associated parameters can be mapped temporally across spatial locations/grid locations to train the modeled physical environment based on grid connectivity.

The modeled physical environment can be simulated a plurality of times to create a plurality of simulated states of the modeled physical environment. Specifically, the modeled physical environment can be simulated a plurality of times to simulate spatial properties of the modeled physical environment at different times. More specifically, the modeled physical environment can be simulated a plurality of times to generate simulated spatial properties at corresponding spatial locations, e.g. grid locations, within the modeled physical environment over time. As will be discussed in greater detail later, the simulated spatial properties can be mapped temporally across the simulated states created at different times to train the physical characterization model. Simulated spatial properties can vary over time, e.g. across simulations and simulated states, at specific spatial locations. For example, a strain value at a grid location can vary across the simulated states of the modeled physical environment as the modeled physical environment is simulated multiple times to generate the simulated states.

In various embodiments, the modeled physical environment is a medium with a natural fracture network. In turn, the simulated spatial properties, e.g. the grid association properties, of the modeled physical environment can include one or a combination of stress in the medium, strain in the medium, permeability of a material in the medium, porosity of the material in the medium, Poisson's ratios of the material in the medium, and Young's modulus of the material in the medium. In certain embodiments, the modeled physical environment is a hydrocarbon reservoir/medium. In turn, the simulated spatial properties, e.g. the grid association properties, of the modeled physical environment can include one or a combination of transmissibility in a medium, pore volume in the medium, pressure in the medium, and saturation in the medium.

At step 202, the physical characterization model is trained. Specifically, the physical characterization model can be trained based on the simulated spatial properties of the modeled physical environment. The physical characterization model can be trained using an applicable machine learning, artificial intelligence, or statistical analysis technique. Specifically, the physical characterization model can be trained using one or a combination of a neural network, a long short term memory network, a gated recurrent unit, and a convolutional long short term memory network.

In training the physical characterization model based on simulated spatial properties of the modeled physical environment, the simulated spatial properties can be mapped to each other across the plurality of simulated states of the modeled physical environment. Specifically, the simulated spatial properties can be temporally mapped to each other across the plurality of simulated states as each of the simulated states is created at a different time, e.g. during a different simulation. For example, a strain value in a first simulated state can be mapped to a different corresponding strain value in a second simulated state to train the physical characterization model. In turn, the physical characterization model can be used, as will be discussed in greater detail later, to predict a strain value in a physical environment.

Further, the simulated spatial properties can be mapped to each other based on spatial locations of the simulated spatial properties within the modeled physical environment to train the physical characterization model. Specifically, simulated spatial properties at the same corresponding spatial locations in the modeled physical environment can be mapped to each other across the different simulated states. More specifically, grid associated properties at the same corresponding spatial locations within the defined spatial grid can be mapped to each other across the different simulated states. For example, a porosity value of a grid square in a first simulated state can be mapped to a different porosity value of the grid square in a second simulated state. In turn, the physical characterization model can be used, as will be discussed in greater detail later, to predict a porosity value in a physical environment, e.g. at or near the grid square.

In training the physical characterization model based on simulated spatial properties mapped according to spatial location, the physical characterization model can be trained based on simulated spatial properties at neighboring and adjacent spatial locations. Specifically, the physical characterization model can be trained based on grid associated properties at neighboring and adjacent grid locations, effectively training the model based on grid connectivity between the neighboring and adjacent grid locations. For example, the physical characterization model can be trained based on varying material characteristics at neighboring grid squares in the modeled physical environment to effectively train the model based on grid connectivity between the neighboring grid squares.

At step 204, the physical characterization model is deployed for predicting one or more physical characteristics of a physical environment. As will be discussed in greater detail later, the physical characterization model can be deployed for predicting one or more physical characteristics of a physical environment based on one or more input states of the physical environment. Input states of a physical environment can include applicable characteristics of a physical environment for use in predicting one or more physical characteristics of the environment using the physical characterization model. For example, an input state of a physical environment can include a size of a physical environment and characteristics of materials within the physical environment.

In various embodiments, steps 200 and 202 of simulating the modeled physical environment and training the physical characterization model can be performed remotely. Specifically, the modeled physical environment can be simulated and the physical characterization model can be trained remote from a physical environment that the physical characterization model is applied to for predicting physical characteristics of the physical environment. For example, the modeled physical environment can be simulated and the physical characterization model can be trained in a cloud computing environment. This is advantageous as the cloud computing environment has computational resources readily available for performing the simulations and the model training. In turn, the physical characterization model can be deployed to or close to the physical environment for application to predict physical characteristics in the physical environment. For example, the physical characterization model can be deployed to a network edge where it can subsequently be used to predict physical characteristics of the physical environment.

In various embodiments, the method shown in FIG. 2 can account for noise. Noise is intrinsic in most systems. Therefore, accounting for noise in generating the physical characterization model can improve the accuracy of the physical characterization model in predicting physical characteristics in the physical environment. Noise can be accounted for in either or both steps 200 and 202. For example, noise can be simulated as part of simulating the modeled physical environment to generate the plurality of simulated states at step 200. In another example, noise can be introduced in the training of the physical characterization model at step 202. In yet another example, noise can be simulated as part of simulating the modeled physical environment and noise can also be introduced in the training of the physical characterization model.

The method shown in FIG. 2 can be implemented in conjunction with operations in an applicable physical environment. Specifically, the method shown in FIG. 2 can be implemented to train a physical characterization model for use in the example wellbore drilling scenario 100 shown in FIG. 1A or with the example system 140 shown in FIG. 1B. More specifically, the method shown in FIG. 2 can be used to predict physical characteristics of a drilling environment, e.g. a hydrocarbon reservoir or natural fracture network, for obtaining hydrocarbons.

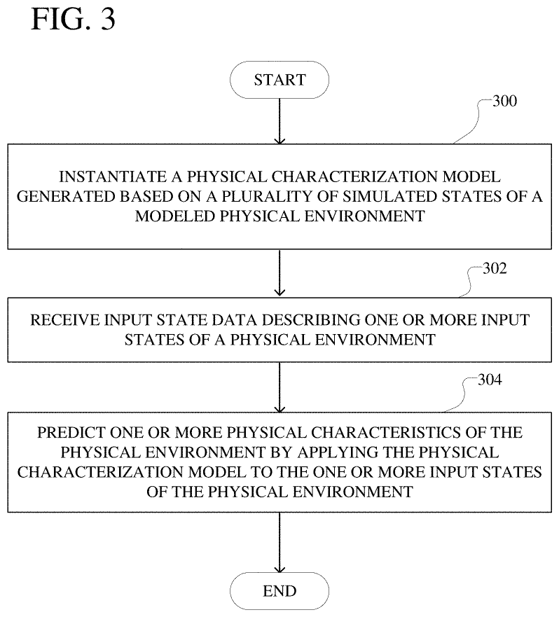

FIG. 3 illustrates a flowchart for an example method of applying a physical characterization model to predict one or more physical characteristics of a physical environment. The method shown in FIG. 3 is provided by way of example, as there are a variety of ways to carry out the method. Additionally, while the example method is illustrated with a particular order of steps, those of ordinary skill in the art will appreciate that FIG. 3 and the modules shown therein can be executed in an applicable different order and can include fewer or more modules than illustrated. Each module shown in FIG. 3 represents one or more steps, processes, methods or routines in the method.

At step 300, a physical characterization model is instantiated for predicting one or more physical characteristics of a physical environment. In instantiating the physical characterization model, the model can be generated and/or deployed. Further, in instantiating the physical characterization model, the model can be loaded for application, e.g. after the model is deployed. For example, the physical characterization model can be instantiated at a network edge after it is generated in a cloud computing environment and deployed to the network edge.

The physical characterization model can be generated using an applicable technique for generating a physical characterization model. Specifically, the physical characterization model can be generated according to the example method shown in FIG. 2. The physical characterization model can be generated based on a plurality of simulated states of a modeled physical environment. In particular, the physical characterization model can be generated by mapping simulated spatial properties temporally across the plurality of simulated states of the modeled physical environment.

At step 302, input state data describing one or more input states of a physical environment are received. As discussed previously, input states of the physical environment can include applicable characteristics of a physical environment for use in predicting one or more physical characteristics of the environment using the physical characterization model. For example, if a physical environment is a natural fracture network in a fracture medium, then input states can include material compositions within the fracture medium.

Input states of the physical environment can specify/define a spatial grid for the physical environment. The spatial grid can split up the physical environment into grid locations and grid spaces based on the spatial grid. In turn and as will be discussed in greater detail later, the spatial grid can be used to predict one or more physical characteristics of the physical environment. The spatial grid can be the same spatial grid used to simulate the modeled physical environment and train the physical characterization model. Alternatively, the spatial grid can be a different spatial grid/refined spatial grid from the spatial grid used to simulate the modeled physical environment and train the physical characterization model. For example, the spatial grid of the physical environment can include smaller grid regions than the spatial grid used to simulate the modeled physical environment.

At step 304, one or more physical characteristics of the physical environment are predicted by applying the physical characterization model to the one or more input states of the physical system. Physical characteristics predicted by the physical characterization model can include applicable characteristics of the physical environment capable of being predicted by the physical characterization model. For example, the physical environment can be a fracture medium where hydraulic fracturing is performed. Further in the example, the predicted physical characteristics of the fracture medium can include either or both stresses and strains in the fracture medium. In another example, the physical environment can be a hydrocarbon reservoir. Further in the example, the predicted physical characteristics of the hydrocarbon reservoir can include one or a combination of pressures in the hydrocarbon reservoir, flow rates in the hydrocarbon reservoir, and saturations in the hydrocarbon reservoir.

The physical environment can be a different physical environment from the modeled physical environment used to generate the physical characterization model. For example, the modeled physical environment can be a physical environment in a different location from the physical environment that the physical characterization model is applied to for predicting one or more physical characteristics. In another example, the modeled physical environment can be a devised physical environment, while the physical environment that the physical characterization model is applied to can be an actual physical environment.

Alternatively, the physical environment can be the same physical environment as the modeled physical environment used to generate the physical characterization model. This is advantageous as the physical environment does not need to be constantly simulated to predict the physical characteristics of the physical environment. Instead, the physical environment only needs to be simulated to create the physical characterization model, after which the physical characterization model can be applied to predict the physical characteristic of the environment. In turn, this conserves computational resources and time as application of the physical characterization model consumes less computational resources and time than actually simulating the physical environment.

The physical characterization model can be applied to predict the one or more physical characteristics based on a defined spatial grid of the physical environment, e.g. as indicated by one or more input states of the physical environment. Specifically, the physical characterization model can be applied to predict the physical characteristics of the physical environment at points and/or regions in the defined spatial grid. For example, the physical characterization model can be applied to predict stresses at ten foot by ten foot regions in the physical environment, as defined by the spatial grid for the physical environment.

All or parts of the defined spatial grid of the physical environment can be modified, e.g. different/refined/coarsened, from the spatial grid of the modeled physical environment, otherwise known as a trained grid, used to create the physical characterization model. Specifically, the defined spatial grid of the physical environment can include smaller grid regions than the spatial grid used to create the physical characterization model. This is advantageous as simulating the physical environment using the smaller grid regions would consumer even more computational resources and time than the spatial grid used to create the physical characterization model. Instead, computational resources and time are conserved through application of the physical characterization model using the smaller grid regions.

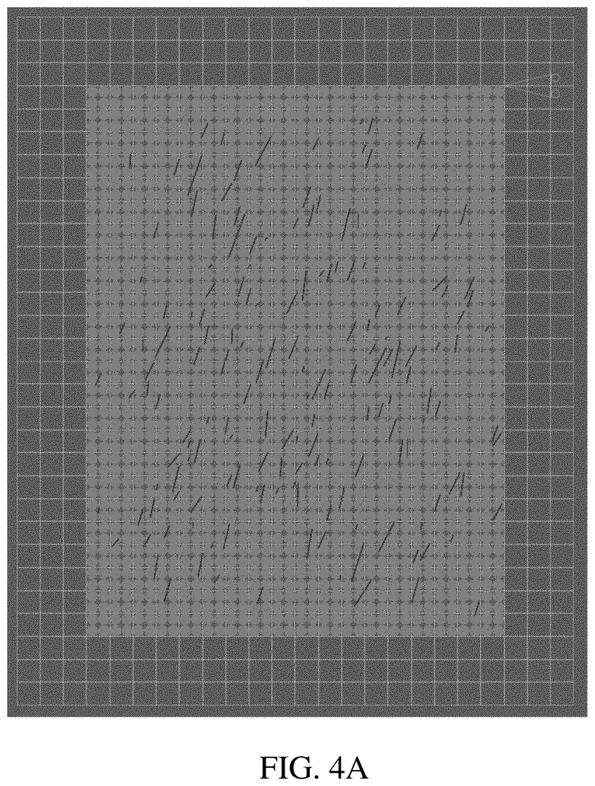

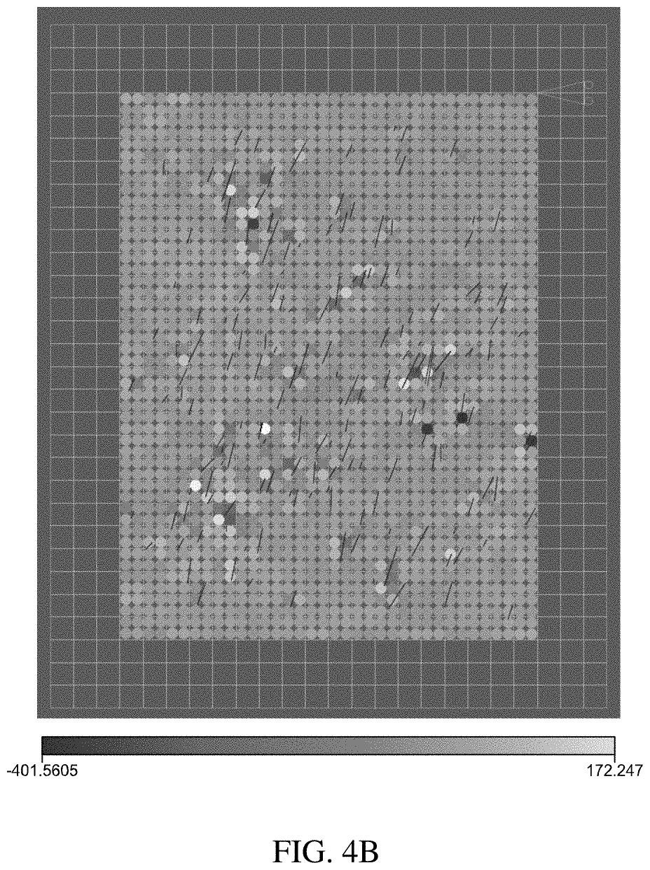

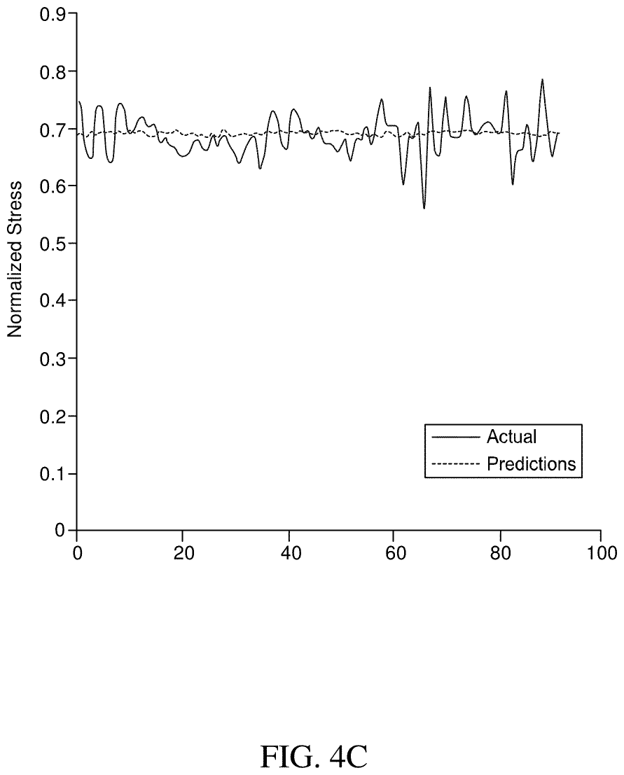

FIG. 4A shows an example stress distribution of a reservoir at an initial state. FIG. 4B shows an example stress distribution of the reservoir at a final state. Both stress distributions of the reservoir at the initial state and the final state, as shown in FIGS. 4A and 4B, are created using a physical simulation. FIG. 4C shows a comparison between the simulated stress distribution at the final state and a stress distribution at the final state predicted using a physical characterization model. Specifically, the physical characterization model can be trained according to the techniques described herein. Further, the simulated stress distribution at the initial state, as shown in FIG. 4A, serves as the input to the physical characterization model for predicting the stress distribution at the final state.

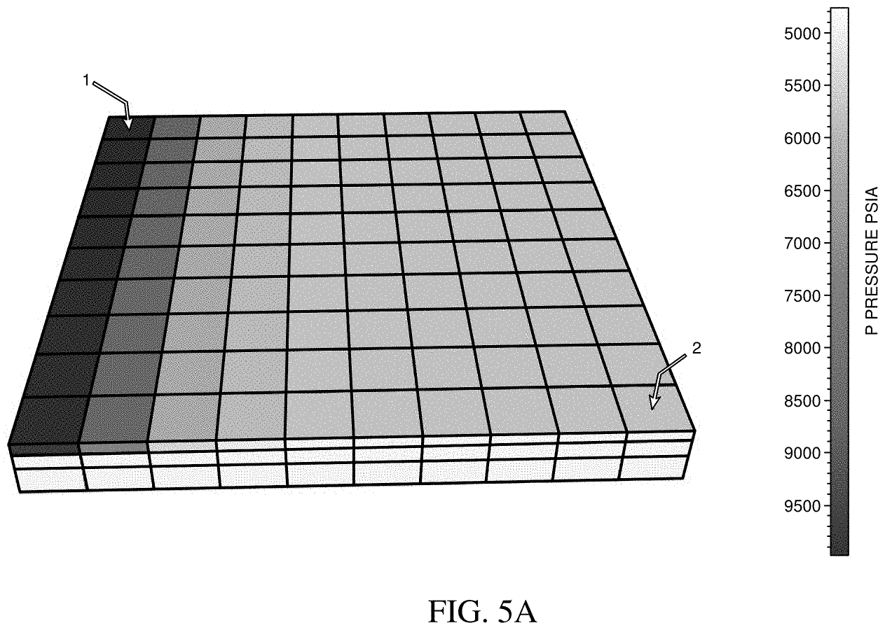

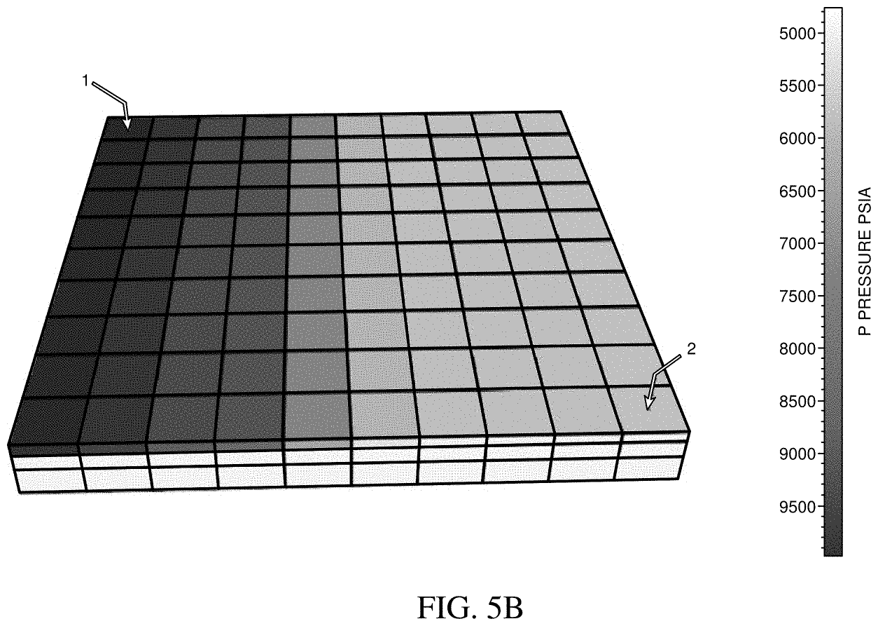

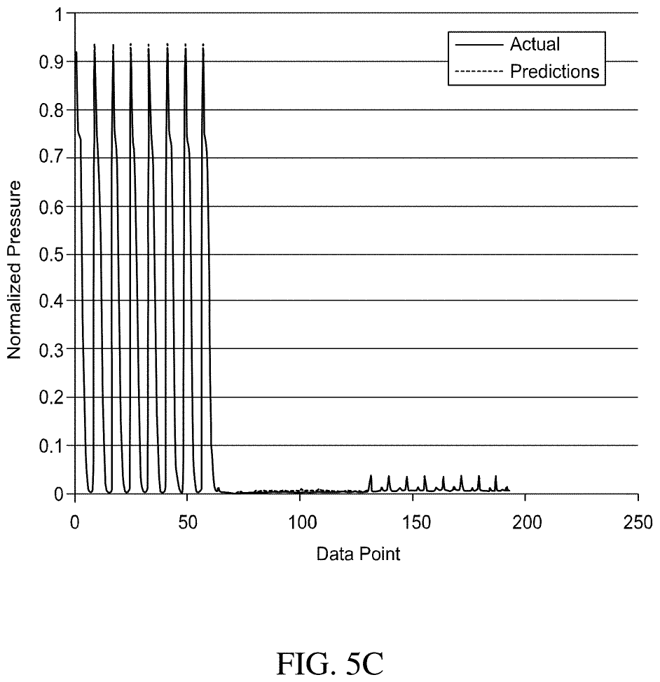

FIG. 5A shows an example pressure distribution of a reservoir at an initial state. FIG. 5B shows an example pressure distribution of the reservoir at a final state. Both pressure distributions of the reservoir at the initial state and the final state, as shown in FIGS. 5A and 5B, were created using a physical simulation. FIG. 5C shows a comparison between the simulated pressure distribution at the final state and a pressure distribution at the final state predicted using a physical characterization model. Specifically, the physical characterization model can be trained according to the techniques described herein. Further, the simulated pressure distribution at the initial state, as shown in FIG. 5A, serves as the input to the physical characterization model for predicting the pressure distribution at the final state.

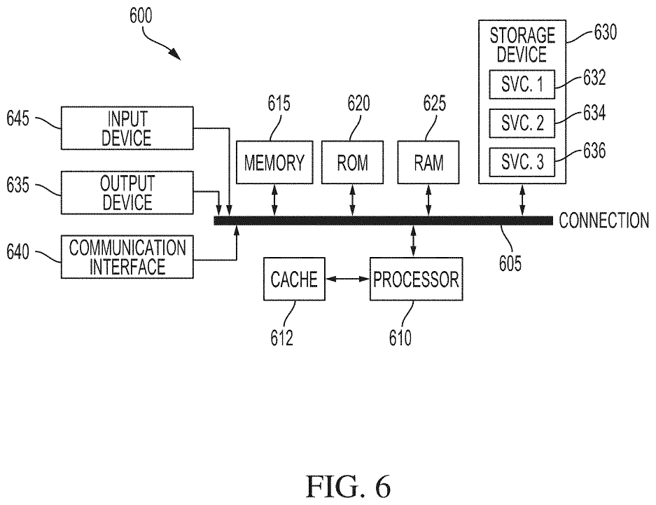

FIG. 6 illustrates an example computing device architecture 600 which can be employed to perform various steps, methods, and techniques disclosed herein. The various implementations will be apparent to those of ordinary skill in the art when practicing the present technology. Persons of ordinary skill in the art will also readily appreciate that other system implementations or examples are possible.

As noted above, FIG. 6 illustrates an example computing device architecture 600 of a computing device which can implement the various technologies and techniques described herein. For example, the computing device architecture 600 can implement the methods shown in FIGS. 2 and 3 and perform various steps, methods, and techniques disclosed herein. The components of the computing device architecture 600 are shown in electrical communication with each other using a connection 605, such as a bus. The example computing device architecture 600 includes a processing unit (CPU or processor) 610 and a computing device connection 605 that couples various computing device components including the computing device memory 615, such as read only memory (ROM) 620 and random access memory (RAM) 625, to the processor 610.

The computing device architecture 600 can include a cache of high-speed memory connected directly with, in close proximity to, or integrated as part of the processor 610. The computing device architecture 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other computing device memory 615 may be available for use as well. The memory 615 can include multiple different types of memory with different performance characteristics. The processor 610 can include any general purpose processor and a hardware or software service, such as service 1 632, service 2 634, and service 3 636 stored in storage device 630, configured to control the processor 610 as well as a special-purpose processor where software instructions are incorporated into the processor design. The processor 610 may be a self-contained system, containing multiple cores or processors, a bus, memory controller, cache, etc. A multi-core processor may be symmetric or asymmetric.

To enable user interaction with the computing device architecture 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art, such as a display, projector, television, speaker device, etc. In some instances, multimodal computing devices can enable a user to provide multiple types of input to communicate with the computing device architecture 600. The communications interface 640 can generally govern and manage the user input and computing device output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof. The storage device 630 can include services 632, 634, 636 for controlling the processor 610. Other hardware or software modules are contemplated. The storage device 630 can be connected to the computing device connection 605. In one aspect, a hardware module that performs a particular function can include the software component stored in a computer-readable medium in connection with the necessary hardware components, such as the processor 610, connection 605, output device 635, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Moreover, claim language reciting “at least one of” a set indicates that one member of the set or multiple members of the set satisfy the claim. For example, claim language reciting “at least one of A and B” means A, B, or A and B.

Statements of the disclosure include:

Statement 1. A method comprising generating a physical characterization model based on a plurality of simulated states of a modeled physical environment. Specifically, the physical characterization model can be trained by mapping simulated spatial properties of the modeled physical environment temporally across the plurality of simulated states of the modeled physical environment. The method can also include receiving input state data describing one or more input states of a physical environment. As follows, one or more physical characteristics of the physical environment can be predicted by applying the physical characterization model to the one or more input states of the physical environment.

Statement 2. The method of statement 1, wherein the simulated states of the modeled physical environment are generated remote from the physical environment in a cloud computing environment and the physical characterization model is deployed to a network edge to predict the one or more physical characteristics of the physical environment.

Statement 3. The method of statements 1 and 2, wherein the modeled physical environment is the physical environment.

Statement 4. The method of statements 1 through 3, wherein the simulated spatial properties of the modeled physical environment are simulated based on a defined spatial grid of the modeled physical environment and the input state of the physical environment is based on a modified spatial grid from the defined spatial grid of the modeled physical environment.

Statement 5. The method of statements 1 through 4, wherein the simulated spatial properties of the modeled physical environment are simulated based on a defined spatial grid of the modeled physical environment and the input state of the physical environment is based on the defined spatial grid of the modeled physical environment.

Statement 6. The method of statements 1 through 5, wherein the simulated spatial properties of the modeled physical environment are generated based on a defined spatial grid of the modeled physical environment.

Statement 7. The method of statements 1 through 6, wherein the simulated spatial properties of the modeled physical environment include grid associated properties of the modeled physical environment at corresponding spatial locations within the defined spatial grid of the modeled physical environment.

Statement 8. The method of statements 1 through 7, wherein the grid associated properties of the modeled physical environment are temporally mapped to each other across the plurality of simulated states of the modeled physical environment based on the spatial locations of the grid associated properties within the defined spatial grid to train the physical characterization model.

Statement 9. The method of statements 1 through 8, wherein the grid associated properties of the modeled physical environment include one or a combination of stress in a medium, strain in the medium, permeability of a material in the medium, porosity of the material in the medium, Poisson's ratios of the material in the medium, and Young's modulus of the material in the medium.

Statement 10. The method of statements 1 through 9, wherein the physical environment is a fracture medium in which hydraulic fracturing is performed to extract hydrocarbons and the one or more physical characteristics of the physical environment include either or both stresses and strains in the fracture medium.

Statement 11. The method of statements 1 through 10, wherein the grid associated properties of the modeled physical environment include one or a combination of transmissibility in a medium, pore volume in the medium, pressure in the medium, and saturation in the medium.

Statement 12. The method of statements 1 through 11, wherein the physical environment is a hydrocarbon reservoir and the one or more physical characteristics of the physical environment include one or a combination of pressures in the hydrocarbon reservoir, flow rates in the hydrocarbon reservoir, and saturations in the hydrocarbon reservoir.

Statement 13. The method of statements 1 through 12, wherein the physical characterization model is trained using one or a combination of a neural network, a long short term memory network, a gated recurrent unit, and a convolutional long short term memory network.

Statement 14. The method of statements 1 through 13, further comprising modeling noise into either or both the simulated states of the modeled physical environment and the physical characterization model.

Statement 15. A system comprising one or more processors and at least one computer-readable storage medium having stored therein instructions. The instructions which, when executed by the one or more processors, cause the one or more processors to perform operations comprising simulating a modeled physical environment to generate a plurality of simulated states of the modeled physical environment. Further, the instructions can cause the one or more processors to train a physical characterization model based on the plurality of simulated states by mapping simulated spatial properties of the modeled physical environment temporally across the plurality of simulated states of the modeled physical environment. Additionally, the instructions can cause the one or more processors to deploy the physical characterization model to predict one or more physical characteristics of a physical environment by applying the physical characterization model to one or more input states of the physical environment.

Statement 16. The system of statement 15, wherein the simulated states of the modeled physical environment are generated remote from the physical environment in a cloud computing environment and the physical characterization model is deployed to a network edge to predict the one or more physical characteristics of the physical environment.

Statement 17. The system of statements 15 and 16, wherein the simulated spatial properties of the modeled physical environment are simulated based on a defined spatial grid of the modeled physical environment and the input state of the physical environment is based on either the defined spatial grid or a modified spatial grid of the defined spatial grid.

Statement 18. The method of statements 15 through 17, wherein the simulated spatial properties of the modeled physical environment include grid associated properties of the modeled physical environment at corresponding spatial locations within the defined spatial grid of the modeled physical environment.

Statement 19. The method of statements 15 through 18, wherein the grid associated properties of the modeled physical environment are temporally mapped to each other across the plurality of simulated states of the modeled physical environment based on the spatial locations of the grid associated properties within the defined spatial grid to train the physical characterization model.

Statement 20. A non-transitory computer-readable storage medium having stored therein instructions which, when executed by a processor, cause the processor to perform operations comprising initiating a physical characterization model generated based on a plurality of simulated states of a modeled physical environment. The physical characterization model can be trained by mapping simulated spatial properties of the modeled physical environment temporally across the plurality of simulated states of the modeled physical environment. The instructions can cause the processor to receive input state data describing one or more input states of a physical environment. Further, the instructions can cause the processor to predict one or more physical characteristics of the physical environment by applying the physical characterization model to the one or more input states of the physical environment.

What is claimed is:

1. A method comprising:
generating a physical characterization model based on a plurality of simulated states of a modeled physical environment, wherein the physical characterization model is trained by mapping simulated spatial properties of the modeled physical environment temporally across the plurality of simulated states of the modeled physical environment;
receiving input state data describing one or more input states of a physical environment; and
predicting one or more physical characteristics of the physical environment by applying the physical characterization model to the one or more input states of the physical environment.

2. The method of claim 1, wherein the simulated states of the modeled physical environment are generated remote from the physical environment in a cloud computing environment and the physical characterization model is deployed to a network edge to predict the one or more physical characteristics of the physical environment.

3. The method of claim 1, wherein the modeled physical environment is the physical environment.

4. The method of claim 3, wherein the simulated spatial properties of the modeled physical environment are simulated based on a defined spatial grid of the modeled physical environment and the input state of the physical environment is based on a modified spatial grid from the defined spatial grid of the modeled physical environment.

5. The method of claim 3, wherein the simulated spatial properties of the modeled physical environment are simulated based on a defined spatial grid of the modeled physical environment and the input state of the physical environment is based on the defined spatial grid of the modeled physical environment.

6. The method of claim 1, wherein the simulated spatial properties of the modeled physical environment are generated based on a defined spatial grid of the modeled physical environment.

7. The method of claim 6, wherein the simulated spatial properties of the modeled physical environment include grid associated properties of the modeled physical environment at corresponding spatial locations within the defined spatial grid of the modeled physical environment.

8. The method of claim 7, wherein the grid associated properties of the modeled physical environment are temporally mapped to each other across the plurality of simulated states of the modeled physical environment based on the spatial locations of the grid associated properties within the defined spatial grid to train the physical characterization model.

9. The method of claim 7, wherein the grid associated properties of the modeled physical environment include one or a combination of stress in a medium, strain in the medium, permeability of a material in the medium, porosity of the material in the medium, Poisson's ratios of the material in the medium, and Young's modulus of the material in the medium.

10. The method of claim 9, wherein the physical environment is a fracture medium in which hydraulic fracturing is performed to extract hydrocarbons and the one or more physical characteristics of the physical environment include either or both stresses and strains in the fracture medium.

11. The method of claim 7, wherein the grid associated properties of the modeled physical environment include one or a combination of transmissibility in a medium, pore volume in the medium, pressure in the medium, and saturation in the medium.

12. The method of claim 11, wherein the physical environment is a hydrocarbon reservoir and the one or more physical characteristics of the physical environment include one or a combination of pressures in the hydrocarbon reservoir, flow rates in the hydrocarbon reservoir, and saturations in the hydrocarbon reservoir.

13. The method of claim 1, wherein the physical characterization model is trained using one or a combination of a neural network, a long short term memory network, a gated recurrent unit, and a convolutional long short term memory network.

14. The method of claim 1, further comprising modeling noise into either or both the simulated states of the modeled physical environment and the physical characterization model.

15. A system comprising:
one or more processors; and
at least one computer-readable storage medium having stored therein instructions which, when executed by the one or more processors, cause the one or more processors to perform operations comprising:
simulating a modeled physical environment to generate a plurality of simulated states of the modeled physical environment;
training a physical characterization model based on the plurality of simulated states by mapping simulated spatial properties of the modeled physical environment temporally across the plurality of simulated states of the modeled physical environment; and
deploying the physical characterization model to predict one or more physical characteristics of a physical environment by applying the physical characterization model to one or more input states of the physical environment.

16. The system of claim 15, wherein the simulated states of the modeled physical environment are generated remote from the physical environment in a cloud computing environment and the physical characterization model is deployed to a network edge to predict the one or more physical characteristics of the physical environment.

17. The system of claim 15, wherein the simulated spatial properties of the modeled physical environment are simulated based on a defined spatial grid of the modeled physical environment and the input state of the physical environment is based on either the defined spatial grid or a modified spatial grid of the defined spatial grid.

18. The system of claim 17, wherein the simulated spatial properties of the modeled physical environment include grid associated properties of the modeled physical environment at corresponding spatial locations within the defined spatial grid of the modeled physical environment.

19. The system of claim 18, wherein the grid associated properties of the modeled physical environment are temporally mapped to each other across the plurality of simulated states of the modeled physical environment based on the spatial locations of the grid associated properties within the defined spatial grid to train the physical characterization model.

20. A non-transitory computer-readable storage medium having stored therein instructions which, when executed by a processor, cause the processor to perform operations comprising:
initiating a physical characterization model generated based on a plurality of simulated states of a modeled physical environment, wherein the physical characterization model is trained by mapping simulated spatial properties of the modeled physical environment temporally across the plurality of simulated states of the modeled physical environment;
receiving input state data describing one or more input states of a physical environment; and
predicting one or more physical characteristics of the physical environment by applying the physical characterization model to the one or more input states of the physical environment.
